(19) United States
(12) Patent Application Publication
(10) Pub. No.: US 2010/0096593 A1
(43) Pub. Date: Apr. 22, 2010

(54) Encapsulated luminescent particulates and aggregates made therefrom

(75) Inventors: Fred Horton, JR., Pt. St. John, FL (US); Robert Howard Kari, Ocoee, FL (US)

Correspondence Address: AKERMAN SENTERFITT, P.O. BOX 3188, WEST PALM BEACH, FL, 33402-3188, US

(73) Assignee: C.L. Industries, Inc., Orlando, FL (US)

(21) Appl. No.: 11/180,813

(22) Filed: Jul. 13, 2005

Related U.S. Application Data
(63) Continuation-in-part of application No. 11/042,679, filed on Jan. 25, 2005.

(51) Int. Cl. C09K 11/58

(52) U.S. Cl. 252/301.36

(57) ABSTRACT

An encapsulated luminescent particle for use in an aqueous environment includes a luminescent pigment capable of being illuminated by an external light source and an encapsulating material, wherein the encapsulated luminescent particles are between about 1.5 mm and about 5 mm in size. The encapsulating material permits luminescence from the luminescent pigment upon excitation by an external light source, such as, a blacklight, while allowing the luminescent pigment to be safely used in an aqueous environment, such as a pool, spa, or the like.

### CROSS-REFERENCE TO RELATED APPLICATIONS

This application is a Continuation-in-Part of U.S. patent application Ser. No. 11/042,679, filed Jan. 25, 2005, the entire contents of which are incorporated herein by reference.

### FIELD OF THE INVENTION

The present invention relates generally to luminescent compounds and more specifically to encapsulated luminescent particles for use in an aqueous environment.

### BACKGROUND OF THE INVENTION

Man-made aqueous environments such as pools, spas, aquariums, ponds and the like often comprise lights to illuminate the aqueous environment. These lights can be submerged in the environment, particularly embedded in a wall of the pool, spa or the like, or directed at the environment. The lights can be used either to illuminate the pool, spa or the like during use, or to give a decorative effect at night or at other times when the pool, spa or the like is not in use. In addition, the lights can comprise numerous colors and shades to provide a desired effect to the aqueous environment.

One alternative to standard electric lighting is the use of luminescent compounds, which may be incorporated into walls and artificial stones to create a decorative effect. Luminescent compounds create a glowing light without consuming excessive amounts of electricity or generating excessive amounts of heat. Luminescent compounds are excited to emit light by certain wavelengths of electromagnetic radiation, generally ultraviolet light (UV).

Prior attempts have been made to create decorative effects using luminescent compounds. These environments generally comprise luminescent pigments that are added directly into the substrate which they are intended to illuminate. However, the luminescent compounds do not provide a good decorative effect in aqueous environments because the luminescent compounds tend to dissolve in water.

U.S. Pat. No. 6,818,153 to Burnell-Jones discloses the addition of luminescent pigment into the gel coat layer of a fiber glass article, such as a pool to create a luminescent substrate. Fillers are added to reinforce the gel coat and provide the underlying fiberglass with the requisite strength to retain its shape and contents. These gel coats are not particles and use fillers that hinder the formation of particles from the gel coats.

U.S. Pat. No. 6,596,074 to Pomeroy discloses the addition of a luminescent compound to an aggregate such as concrete or mortar. The patent teaches the addition of a luminescent pigment directly into an aggregate mixture. In application, such a mixture is not effective as the luminescent compound is significantly diluted among the aggregate and its luminescent qualities are severely diminished. Accordingly, there is little or no luminescent effect in the underlying aggregate.

An attempt was made to microencapsulate luminescent compounds. United States Patent Application Publication Number 2004/0011256 to Beimel discloses microencapsulated luminescent particles. The microcapsules disclosed have a size between about 0.0007 mm and 0.200 mm in dimension and contain luminescent materials that require charging by a light source prior to illumination. Drawbacks to such particles are that their small size makes handling the particles difficult, in addition to the difficulties of preparing such small particles. Further, a very large quantity of particles is required to provide a luminescent effect, which makes the use of such particles expensive.

The documents and publications cited in this disclosure are incorporated by reference in their entirety, to the extent they are not inconsistent with the explicit teachings set forth herein.

It would be beneficial to provide an encapsulated luminescent particle that can be capable of being effectively used in an aqueous environment. It would also be beneficial to provide an encapsulated luminescent particle that may be encapsulated in particulate form without the need for excess materials. It would also be beneficial to provide an encapsulated luminescent particle that may be admixed with other materials and used in the formation of various aqueous substrates.

### SUMMARY OF THE INVENTION

Accordingly, it is an object of the present invention to provide a luminescent particle for an aggregate. More specifically, it is an object of the present invention to provide an encapsulated luminescent particle for mixture with substrate material.

Aspects of the invention include an encapsulated luminescent particle for use in an aqueous environment including a luminescent pigment and an encapsulating material, wherein the encapsulating material permits luminescence from the luminescent pigment upon excitation by an external light source and wherein the encapsulated luminescent particle is between about 1.25 mm and about 10 mm in size. In a preferred arrangement, the particle size is between about 1.5 mm and about 5.5 mm. The external light source can include light from the UV range of the electromagnetic radiation spectrum and can be produced by a blacklight.

The encapsulated luminescent particles can be included in an aqueous environment, such as, for example, a pool, a spa, an aquarium, a fountain, or a pond.

Aspects of the invention further contemplate encapsulated luminescent particles including a UV stabilizer to prevent UV degradation.

The encapsulated luminescent particles can include encapsulating material such as resins, silicates, quartz, or a combination thereof.

Aspects of the invention also contemplate an aggregate for use in an aqueous environment including encapsulated luminescent particles, wherein the particles comprise a luminescent pigment and an encapsulation material and are between about 1.25 mm and about 10 mm in size, preferably about 1.5 mm to about 5.5 mm. The aggregate also includes cement; and at least one other material selected from lime, sand, marble, rock, clay, kaolin, silica, calcium, magnesium, polyester, polyethylene, or a combination thereof. The particles in the aggregate can illuminate upon excitation by an external light source. The encapsulated luminescent particles can be between about 0.5% and 5% of the aggregate by weight and, more preferably, about 1.5% by weight.

Aspects of the invention include use of the aggregate to create a substrate in an aqueous environment, such as a pool; a spa; an aquarium; a fountain; or a pond.

Aspects of the present invention further contemplate a method of manufacturing encapsulated luminescent particles for use in an aqueous environments that includes admixing a luminescent pigment with a resin to create a substantially homogenous mixture. Admixing a catalyst to the mixture wherein the catalyst chemically reacts with the mixture to create a substantially solid composition. Granulating the substantially solid composition to produce encapsulated luminescent particles. The method can include admixing a UV stabilizer prior to admixing the catalyst to prevent UV degradation.

Embodiment of the invention can include sizing the encapsulated luminescent particles to yield particles of substantially similar size. Sizing can be performed by passing the particles through a series of sizing screens. Preferably, the particles are sized to yield particles between about 1.25 mm and about 10 mm in size, most preferably about 1.5 mm to about 5.5 mm.

Embodiments of the invention include a method of manufacturing a luminescent aggregate for use in an aqueous environment that includes obtaining an aggregate and encapsulated luminescent particles between about 1.25 mm and about 10 mm in size comprising a resin, a luminescent pigment and a catalyst. Admixing the encapsulated luminescent particle into the aggregate at a concentration sufficient to impart a luminescent characteristic in the aggregate. Preferably the encapsulated luminescent particle has a size of about 1.5 mm to about 5.5 mm. The concentration of particles can be between about 0.5% and 5% of the luminescent aggregate mixture by weight and more preferably, about 1.5% of the mixture by weight. The aggregate can include cement and at least one other material selected from lime, sand, marble, rock, clay, kaolin, silica, calcium, magnesium, polyester, polyethylene, or any combination thereof.

Aspects of the invention also include method of using a luminescent aggregate in an aqueous environment comprising that includes obtaining an aggregate having encapsulated luminescent particles between about 1.25 mm and about 10 mm in size, wherein the particles comprise a resin, a luminescent pigment, and a catalyst, and forming a substrate using said aggregate. Preferably the particles are between about 1.5 mm and about 5.5 mm.

### DETAILED DESCRIPTION OF THE INVENTION

Luminescent compounds emit light that does not derive energy from the temperature of the emitting body, which may be due to phosphorescence, fluorescence, or bioluminescence. Luminescence is caused by chemical, biochemical, or crystallographic changes, the motions of subatomic particles, or radiation-induced excitation of an atomic system. Phosphorescence is the persistent emission of light following exposure to and removal of incident radiation. Fluorescence is the emission of light or other radiation, stimulated in a substance by the absorption of incident radiation and persisting only as long as the stimulating radiation is continued. Commercial examples of luminescent pigments sold in varying colors are those available under the Lumilux® brand of pigments produced by Honeywell. The Lumilux® pigments are particularly well suited for the present invention. Suitable pigments such as those available under the Lumilux® brand include alkaline earth aluminates such as calcium aluminate and strontium aluminate, which may or may not be doped with other elements.

Aspects of the present invention contemplate encapsulated luminescent particles for use in aqueous environments. The encapsulated luminescent particles, in one embodiment, can include a luminescent pigment and an encapsulating material. By way of example, the luminescent pigment, such as Lumilux® and the like, may be encapsulated within an encapsulating material, such as resin, quartz, silicates (including glass) or any other transparent and/or translucent material. In alternative embodiments, the mixture may be a substantially homogeneous mixture. After the composition is formed, and molded into a hardened block, it may be ground and passed through one or more sizing screens to yield encapsulated particles of substantially similar size.

When the selected size particles are isolated, they may then be admixed with an aggregate material such as, for example, cement, mortar or grout wherein the encapsulated particles become an integral portion of the aggregate. The luminescent containing aggregate may be used to form a substrate, for example to form a plaster for the wall of a swimming pool. Due to the fact that the luminescent pigments are encapsulated within the encapsulating material, and thus protected from dissolving in any surrounding water, the luminescent particles are especially useful in aqueous environments including, but not limited to, pools, spas, fountains, aquariums or ponds.

It is important to note that encapsulating the luminescent pigment in the encapsulating material helps to obtain the luminescent effect in aggregates such as concrete, mortar or grout. Encapsulation prior to introduction into an aggregate prevents the dilution of the luminescent pigment in water and permits each particle having exposure to an external light source to illuminate independently. In manufacturing the encapsulated luminescent particles, fillers are not needed due to the filler's tendency to dilute the luminescent characteristic of the particle as well as potentially interfere with the formation of smaller particles, although fillers may be used in certain applications if desired.

Particles of different sizes may be used in various mixture concentrations to provide a wide variety of luminescent effects. For example, higher concentrations of finer particulates may be used to create a uniform full glow effect in the substrate, whereas reducing the concentration of the particles and increasing the size of the particles may be used to create a starry or speckled effect in the substrate. The encapsulated luminescent particles can comprise numerous shapes and sizes. For example, the particles can comprise uniform shapes, such as, spheres and cubes, or irregular shapes having no uniform dimensions. It is suggested that irregularly shaped particles create a more desired lighting effect in a substrate as the requirement for positioning of the particle for example, in relation to other particles, in generally non-existent. Additionally, the light effects produced are random and speckled, which can give the final aggregate a sparkly appearance. Furthermore, the irregular shaped particles offer different facets and planes to the irradiating radiation, and therefore can receive differing amounts of excitation, which can produce a variation in the amount of light emitted by the particles.

To create the appropriate wavelength of light, special lights, or lights comprising special filters can be used to provide the excitation radiation, or natural daylight may be used. For example, a blacklight can be used. Blacklights are fluorescent or incandescent lamps that can emit UV light and can cause phosphorescent or fluorescent compounds to illuminate. Because blacklights generally emit only faintly in the visible part of the electromagnetic spectrum, and typically emit purple visible light, it is difficult for a person to see the excitation with the naked eye. Most of the light emitted by a blacklight is UV radiation that cannot be seen with the naked eye. The illumination of a phosphorescent or fluorescent compound with a blacklight thus creates a glowing effect without a user being aware of the lighting used for excitation. This creates a particularly pleasing decorative effect at night.

In addition to the luminescent compound, the luminescent particles of the present invention also include an encapsulating material. As used herein an “encapsulating material” is any material capable of encapsulating a luminescent compound while permitting luminescence from the luminescent pigment to be viewed in an aqueous environment. As such, in select embodiments of the present invention, the encapsulating material is a substantially transparent and/or translucent material. Examples of encapsulating materials that may be used in the present invention include, but are not limited to silicates (including glass), quartz, resins, or a combination thereof.

Resins are classes of solid, semi-solid or liquid organic products of natural or synthetic origin, generally of high molecular weight with no definite melting point. When catalyzed, the resin cures by undergoing a polymerization process, transforming the resin into a solid. Resins may be used in the present invention to surround and hold the luminescent compound to form solid compositions. Many resins are translucent and/or transparent. Examples or resins useful in the present invention include, but are not limited to, acrylics, alkyds, copal esters, epoxies, polyurethanes, polyesters, polyvinyl chlorides, silicones, vinyls, vinyl esters, or any other resin capable of encapsulating a luminescent pigment.

If a resin is used as the encapsulating material, then a catalyst may be used to assist in the formation of the luminescent particles. Catalysts, also known as resin activators or hardeners, are substances that increase the rate of chemical reactions without being consumed in the reactions. Catalysts may be used to lower the activation energy for a chemical reaction by providing an alternate pathway for the reaction. Example of catalysts that may be used in the present invention include, but are not limited to, vinylbenzene, di-vinylbenzene or any other catalyst or resin activator capable of polymerizing a luminescent/resin mixture to create a substantially solid composition.

In alternative embodiments, an ultraviolet stabilizer may be added to the luminescent particle to maintain the integrity of the mixture when exposed to UV light and prevent premature degradation caused by exposure. The stabilizer may be added to the luminescent particle during the formation of the particle. In alternative embodiments, more than one UV stabilizer may be used.

The luminescent particles are, in one embodiment, substantially solid. The particles may be formed by mixing the luminescent pigment with the encapsulating material, such as resin, together with any other compounds that are desired, such as the UV stabilizer. The mixture may be heated, and placed in a mold to form a solid block. The substantially solid block may then be broken or ground by mechanical or other means into particles. The resulting particles may be sized by known methods, such as, for example, passing the particles thought a series of sizing screens to isolate particles of substantially similar size. Once the particles have been sized, they may be admixed with an aggregate. It should be noted, however, that in some embodiments, the particles may be admixed with the aggregate without sizing them depending on the selected characteristics of the final aggregate. In general, the particles contemplated by the invention are between about 1.25 mm and about 10 mm in size, and the size of the aggregate particles are the same as or similar to the size of the luminescent particles. Preferably, the particles used in an aggregate have a similar size to one another. Preferably, also, the particles sizes are between about 1.5 mm and 5.5 mm. For example, the particle sizes that are used may be between 1.52 mm (0.06″) and 3.35 mm (0.132″) in one application, or between 3.35 mm (0.132″) and 5.15 mm (0.203″) in another application, which are generally accepted aggregate sizes used in pool plasters.

Aggregates that may be used in the present invention include, but are not limited to, concrete, mortar, grout and the like. Aggregates generally include cement in addition to additives, such as lime, sand, marble, rock, clay, kaolin, silica, calcium, magnesium polyester, polyethylene, as well as commercial additives, such as Marble XO, Marble CP Filler, Optiwhite, Hi-Fibe 254, NYAD-G, RP 226, RP 245, Colored Aggregate Blue, Metastar, Easyspred, Super Air Plus, Clay Thickener 40, or any combination thereof. The encapsulated luminescent particles are added to the aggregate mixture prior to setting the mixture as a substrate. Because of the encapsulated nature of the luminescent particles, there is no need to specially treat the aggregate mixture prior to the addition of the particles.

The invention contemplates an encapsulated luminescent particle that is generally white in color, under normal conditions, that will blend with its surrounding aggregate to create a surface that is substantially uniform in color. When the particles are excited by an external light source emitting the appropriate wavelength of light, the particles themselves then emit light in a color consistent with the color of the luminescent compound used therein. For example, under normal lighting conditions the surface of a pool could have a substantially uniform white surface. Once the appropriate external light source is applied to the surface of the pool, the encapsulated luminescent particle could begin to emit, for example, a yellow color light throughout the pool. To create the desired illumination, one aspect of the present invention contemplates a mixture of aggregate comprising between about 0.5% and 5% encapsulated luminescent particles. More specifically, about 1.5% encapsulated luminescent particles is desired.

The aggregates may be used to form a variety of different substrates, such as plasters for pools, spas, fish ponds and the like. Since the encapsulating material permits luminescence from the luminescent compound to be viewed in an aqueous environment, the aggregates are especially beneficial in forming these aqueous substrates to add a luminescent characteristic to these environments.

One feature of the instant invention that is beneficial to applying the encapsulated luminescent particles to a substrate is the density of the particles in relation to the aggregate materials in which they are admixed. Because the particles are generally less dense that the surrounding mixture, when applied, for example, on the surface of an aqueous environment, such as a pool, the particles generally rise to the surface where they are desired. With larger particles, the differences in density between the aggregate and the luminescent particles becomes more pronounced, and larger particles will thus rise to the surface of the substrate relatively quickly. This ensures that the luminescent particles are close to the surface where the phosphorescence or fluorescence may be more easily seen.

Once the substrate is sufficiently set, the surface can be treated to more fully expose a surface of the encapsulated particles, while allowing the particles to remain in their encapsulated form. The greater the amount of the surface area of the particle that is exposed, the greater amount of light it will emit. To properly treat the surface of the particles the surface may be acid washed with muriatic acid or other acid as is known in the pool finishing art to remove any excess materials from the surface of the particles. In another embodiment, the surface of the particles can be ground with an abrasive as is known in the pool finishing art to remove excess materials and more fully expose the surface of the materials.

### EXAMPLES

### Example 1

Phosphorescent Composition

| | | |
|---|---|---|
| 19 | oz. | polyester casting resin |
| 2.85 | oz. | Lumilux ® luminescent pigment |
| 0.5 | oz. | vinylbenzene (styrene) catalyst |

Example 1 represents a formulation of the underlying encapsulated luminescent composition prior to granulation according to aspects of the present invention.

### Example 2

| | | |
|---|---|---|
| 2500 | lbs | white cement |
| 5325 | lbs | Marble XO |
| 650 | lbs | Marble CP Filler |
| 100 | lbs | encapsulated luminescent particles |
| 400 | lbs | lime |
| 10 | lbs | Optiwhite |
| 15 | lbs | HiFibe 254 |

Example 2 represents an aggregate mixture that may be used for creating a substrate according to aspects of the present invention.

### Example 3

| | | |
|---|---|---|
| 4370 | lbs | 295 Blend Sand |
| 2900 | lbs | white cement |
| 100 | lbs | encapsulated luminescent particles |
| 550 | lbs | colored aggregate blue |
| 25 | lbs | NYAD G |
| 20 | lbs | Hi-Fibe 254 |
| 10 | lbs | RP 254 |

Example 3 represents an alternate embodiment of an aggregate mixture that may be used for creating a substrate according to aspects of the present invention.

### Example 4

| | | |
|---|---|---|
| 4330 | lbs | 295 Blend Sand |
| 2975 | lbs | white cement |
| 100 | lbs | encapsulated luminescent particles |
| 550 | lbs | colored aggregate blue |
| 25 | lbs | NYAD G |
| 20 | lbs | Hi-Fibe 254 |

Example 4 represents an additional embodiment of an aggregate mixture that may be used for creating a substrate according to aspects of the present invention.

### Example 5

| | | |
|---|---|---|
| 3100 | lbs | white cement |
| 100 | lbs | encapsulated luminescent particles |
| 4700 | lbs | rock 8/16 |
| 50 | lbs | Metastar |
| 50 | lbs | Hi-Fibe 254 |

Example 5 represents another alternate embodiment of an aggregate mixture that may be used for creating a substrate according to aspects of the present invention.

### Example 6

| | | |
|---|---|---|
| 6245 | lbs | white cement |
| 100 | lbs | encapsulated luminescent particles |
| 4900 | lbs | rock 6/10 |
| 26 | lbs | easy spread |
| 20.75 | lbs | Hi-Fibe 254 |
| 0.12 | lbs | Super Air Plus |

Example 6 represents an additional alternate embodiment of an aggregate mixture that may be used for creating a substrate according to aspects of the present invention.

### Example 7

Ceramic grout

| | | |
|---|---|---|
| 1127.984 | lbs | white cement |
| 1238.029 | lbs | sand |
| 30 | lbs | encapsulated luminescent particles |
| 15.001 | lbs | clay thickener |
| 2.249 | lbs | RP226 |
| 7.483 | lbs | calcium formate |

Example 7 represents an alternate embodiment of an aggregate mixture comprising ceramic grout that may be used for creating a substrate according to aspects of the present invention.

The preceding disclosure presents the best mode devised by the inventor for practicing the invention and is intended to enable one skilled in the pertinent art to carry it out, it is apparent that methods incorporating modifications and variations will be obvious to those skilled in the art. As such, it should not be construed to be limited thereby but should include such aforementioned obvious variations and be limited only by the spirit and cope of the following claims. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

1-21. (canceled)

22. A method of manufacturing a substrate for use in an aqueous environment comprising:
obtaining an aggregate;
obtaining encapsulated luminescent particles between about 1.25 mm and about 10 mm in size comprising a resin, a luminescent pigment, a catalyst and a UV stabilizer, the luminescent pigment being a ZnS:Cu phosphor;
admixing the encapsulated luminescent particles with the aggregate at a concentration sufficient to impart a luminescent characteristic in said aggregate to form the substrate, wherein the formed substrate is waterproof, wherein the encapsulated particles have a density less than the density of the aggregate thereby causing the encapsulated luminescent particles to be positioned in proximity to a surface of the substrate.

23. The method of claim 22, wherein said encapsulated luminescent particles are formed without a filler.

24. The method of claim 22, wherein the concentration of said encapsulated luminescent particle is between about 0.5% and 1.5% of the luminescent aggregate mixture by weight.

25. The method of claim 22, wherein the aggregate comprises cement.

26. The method of claim 22, wherein the concentration of said encapsulated luminescent particle is between about 0.5% and 5% of the luminescent aggregate mixture by weight.

27. The method of claim 26, wherein the concentration of said encapsulated luminescent particle is about 1.5% of the luminescent aggregate mixture by weight

28. The method of claim 22, wherein the resin is chosen from the group consisting essentially of acrylics, alkyds, copal esters, epoxies, polyurethanes, polyesters, polyvinyl chlorides, silicones, vinyls, and vinyl esters.

29. The method of claim 28, wherein the catalyst is chosen from the group consisting essentially of vinylbenzene and di-vinylbenzene.

30. The method of claim 22, wherein said aggregate is comprised of cement and at least one other material selected from: lime; sand; marble; rock; clay; kaolin; silica; calcium compounds; magnesium compounds; polyester; polyethylene; or any combination thereof.

31. A method of using a luminescent aggregate in an aqueous environment comprising:
obtaining an aggregate having encapsulated luminescent particles between about 1.25 mm and about 10 mm in size, wherein said particles comprise a resin, a luminescent pigment, a catalyst and a UV stabilizer, and wherein the luminescent pigment is a ZnS:Cu phosphor;
forming a substrate using said aggregate, wherein the formed substrate is waterproof;
applying UV radiation to the substrate using a blacklight thereby causing the encapsulated luminescent particles to illuminate.

32. The method of claim 31, wherein the catalyst is chosen from the group consisting essentially of vinylbenzene and di-vinylbenzene, and wherein the encapsulated particles have a density less than the density of the aggregate thereby causing the encapsulated luminescent particles to be positioned in proximity to a surface of the substrate.

33. The method of claim 31, wherein the resin is chosen from the group consisting essentially of acrylics, alkyds, copal esters, epoxies, polyurethanes, polyesters, polyvinyl chlorides, silicones, vinyls, and vinyl esters.

34. The method of claim 31, wherein said encapsulated luminescent particles are sized between about 1.5 mm and about 5.5 mm.

35. The method of claim 31, wherein the concentration of said luminescent particles is between about 0.5% and about 5% of the luminescent aggregate mixture by weight.

36. The method of claim 35, wherein the concentration of said luminescent particles is about 1.5% of the luminescent aggregate mixture by weight.

37. The method of claim 31, wherein said substrate is a wall of the aqueous environment.

38. The method of claim 37, wherein said aqueous environment is selected from the group consisting of: a pool; a spa; an aquarium; a fountain and a pond.

39. The method of claim 31, wherein said aggregate is comprised of cement and at least one other material selected from the group consisting of lime; sand; marble; rock; clay; kaolin; silica; calcium compounds; magnesium compounds; polyester; polyethylene, or any combination thereof.

40. The method of claim 31, wherein the particles are formed without a filler.

41. A method of manufacturing a substrate for use in an aqueous environment comprising:
obtaining an aggregate comprising wollastonite;
obtaining encapsulated luminescent particles between about 1.25 mm and about 10 mm in size comprising a resin, a luminescent pigment, a catalyst and a UV stabilizer, the luminescent pigment being a ZnS:Cu phosphor;
admixing the encapsulated luminescent particles with the aggregate at a concentration sufficient to impart a luminescent characteristic in said aggregate to form the substrate, wherein the formed substrate is waterproof, wherein the encapsulated particles have a density less than the density of the aggregate thereby causing the encapsulated luminescent particles to be positioned in proximity to a surface of the substrate.

42. The method of claim 41, wherein the aggregate comprises magnesium silicate hydrate.

43. The method of claim 41, wherein the aggregate comprises metakaolin.
